(19) United States
(12) Patent Application Publication
(10) Pub. No.: US 2016/0260113 A1
(43) Pub. Date: Sep. 8, 2016

(54) SYSTEMS AND METHODS FOR VISUALIZING PERFORMANCE, PERFORMING ADVANCED ANALYTICS, AND INVOKING ACTIONS WITH RESPECT TO A FINANCIAL INSTITUTION

(71) Applicant: Saggezza Inc., Chicago, IL (US)

(72) Inventor: Steven D. Simpson, Lake City, FL (US)

(21) Appl. No.: 15/052,333

(22) Filed: Feb. 24, 2016

Related U.S. Application Data
(60) Provisional application No. 62/129,618, filed on Mar. 6, 2015.

(51) Int. Cl. G06Q 30/02; G06Q 40/02

(52) U.S. Cl. CPC G06Q 30/0205; G06Q 30/0204; G06Q 40/02

(57) ABSTRACT

A customer metric is calculated for customer records corresponding to a plurality of customers and recording banking activities and/or attributes of the plurality of customers. A target segment is identified based on the metrics by comparing the metric to a threshold condition. The target segment is divided into action segments and a different customer development action is performed for each segment. Logistic regression is performed with respect to the action segments and cluster equations are generated that describe sub-segments that have combinations of activities and attributes that are indicative of a positive response to the customer development action. The process may be repeated for the sub-segments using the same or a different metric thereby identifying more and more specific sub-groups of customers that respond similarly.

### RELATED APPLICATIONS

This application claims the benefit of U.S. Provisional Application Ser. No. 62/129,618 filed Mar. 6, 2015 and entitled SYSTEMS AND METHODS FOR VISUALIZING PERFORMANCE, PERFORMING ADVANCED ANALYTICS, AND INVOKING ACTIONS WITH RESPECT TO A FINANCIAL INSTITUTION, which is hereby incorporated by reference in its entirety.

### BACKGROUND

1. Field of the Invention

This invention relates to systems and methods for analyzing performance of financial institutions.

2. Background of the Invention

Financial institutions face enormous challenges. For example, strict regulations reduce profit potential considerably. Likewise, low economic growth also reduces growth opportunities for financial institutions. The prevalence of online banking and aggressive competition, both from other financial institutions and non-financial institutions, results in decreased customer loyalty, which likewise reduces the ability of financial institutions to generate profit. These challenges are particularly acute for smaller financial institutions that continue to lose market share to larger banks.

The systems and methods described herein provide an improved approach for financial institutions to identify growth opportunities, increase revenue, and improve cross selling and retention.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIGS. 1 is a schematic block diagram of a network environment suitable for implementing methods in accordance with embodiments of the invention;

FIG. 2 is a schematic block diagram of an example computing device suitable for implementing methods in accordance with embodiments of the invention; and

FIG. 3 is a process flow diagram of a method for computerized selection of customers for development actions in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

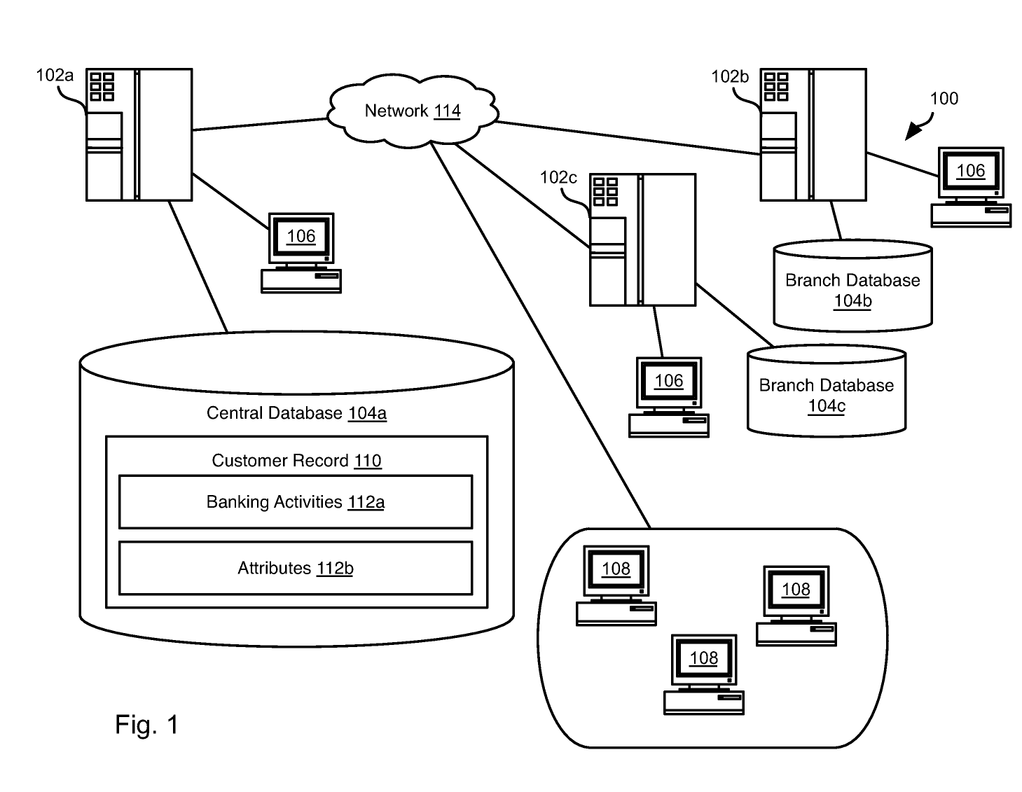

Referring to FIG. 1, a network environment 100 may be used to implement methods as described herein. The environment 100 may include a server system 102a associated with a corporate parent or controlling entity having one or more physical branches associated therewith. The server system 102a may, for example, be in data communication with various server systems 102b-102c associated with and possibly located at the various branches. Server systems 102a-102c may interact with employees of the controlling entity by computing devices 106 located at the various branches or otherwise operated by employees assigned to the various branches.

The server system 102a may host or access a user database 104a that stores analytical tools and results of analytical tools that operate on data gathered from the various branches. For example, branches may have databases 104b, 104c hosted or accessed by the various server systems 102b, 102c. The data of the databases 104b, 104c may be accessed and copies thereof possibly stored by the server system 102a for use in performing the methods described herein.

The database 104a of the server system 104a may include various customer records 110 that include data recorded for customers that may be used according to the methods described herein. For example, the user record 110 for a user may include a listing of banking activities 112a (open accounts, transactions, in-bank visits, etc.) and attributes (age, gender, geographic location, occupation, income, and other demographic attributes). Banking activities 112a may be stored in the customer record 110 in response to reporting of such activities by the server systems 102b, 102c, such as by providing data recorded in corresponding branch databases 104b, 104c.

Representatives of a financial institution may access the server system 102a in order to participate in the methods described herein by means of the user computers 108 that may be embodied as desktop or laptop computers, tablet computers, smart phones, or the like. Communication among servers 102a-102c, employee computers 106, and user computers 108 may occur over a network 114 such as the Internet, local area network (LAN), wide area network (WAN) or any other network topology. Communication may be over any wired or wireless connection.

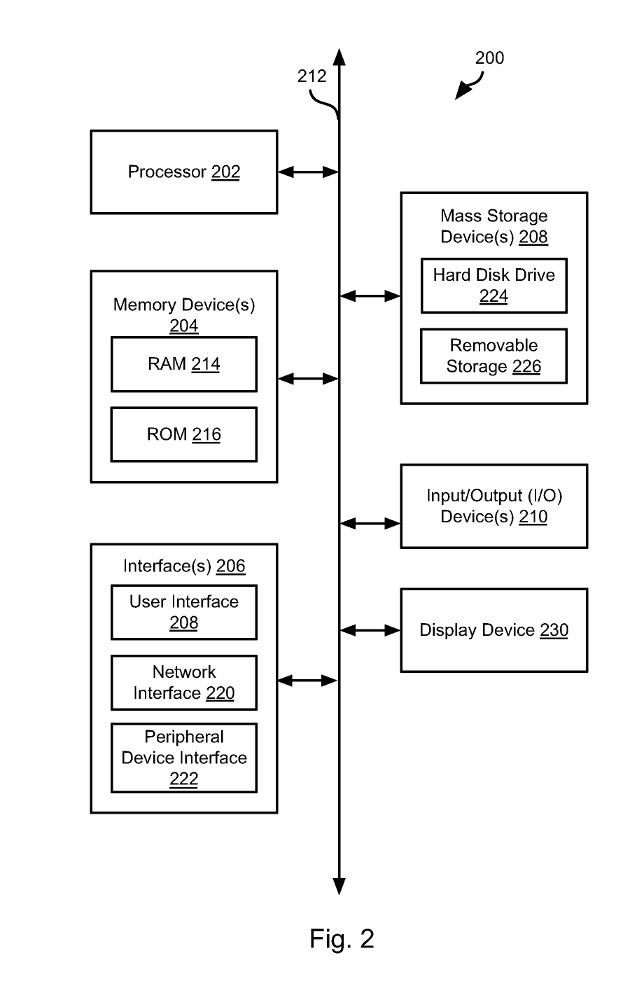

FIG. 2 is a block diagram illustrating an example computing device 200. Computing device 200 may be used to perform various procedures, such as those discussed herein. A server system 102a-102c, employee computers 106, and customer computing device 108 may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, tablet computer and the like. A server system 102a-102c may include one or more computing devices 200 each including one or more processors.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more user interface elements 218. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, and I/O device(s) 210 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

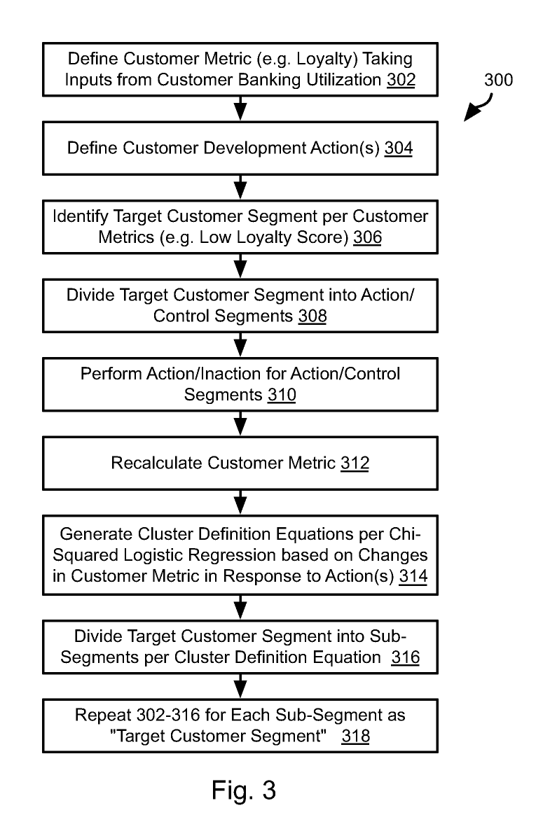

Referring to FIGS. 3-45, a Value Finder as created and used according to the methods shown in FIGS. 3-45 provides a tool to improve specific segments of data: improve customer profit, improve customer retention, or add targeted products or services. FIGS. 46-67 illustrate a method for simulating a “battle” between branches, regions, and account or loan officers at the same or different periods in time. The interfaces and actions shown in FIGS. 3-67 may be executed on a server system 102a or employee computing device 106 with inputs received from, and interfaces displayed on, the employee computing device 106 as illustrated. In particular, actions provided to the user may be provide by executable code executing on one or both of the server system 102a and employee computing device 106 and the displaying of the interfaces shown may be performed by one or both of the server system 102a and computing device 106 in response to the user inputs described below.

Some examples of intuitive opportunities that may be identified using a Value Finder may include:

Customers with a mortgage, 5 years old+, have built equity. Those customers with no Home Equity Line of Credit (HELOC), a mortgage 5+ years old, using an estimate of property value, integrated with financial institution data from an outside data source to identify homes with equity, and good credit score would be easy targets for a HELOC. With the methods disclosed herein the bank can further refine by customer income, by the area in which they live, etc.

Customers with a checking account but no debit card. In reality this would be multiple Value Finders as it would be a different action for such customers versus those with a debit card but little or no use, versus those with too many PIN transaction (financial institutions prefer credit transactions), those with 10-20 vs. 20-40 and those with 40+ would be directed to rewards programs as they'd be very profitable customers the bank would want to keep.

Show all loans maturing within 6 months—graphically the user is shown a type of scatter plot with a centerline=average interest rate for loans of this type of loan. Of course the outliers would be of interest. Each officer can see this for their loan portfolio. User can easily change the type of loan from consumer to auto or just corporate and then drill into those for Doctors vs. lawyers or real-estate collateralized, fixed vs. adjustable, etc.

Using graphic above, imagine two quite different action items for the loans above the average rate line—those you want to retain so drop by a renewal package early before the customer shops other rate offers at other banks. Compare this to the action needed for loans below the line. Either this loan was an accommodation for a profitable customer or the loan officer needs to be ready to negotiate a higher rate

Same graphic easily identifies deposit outliers—why such a high rate as the users drill through different types of deposits, different maturities of CDs

Profitable customers with few accounts and services—increase products and services to increase retention

Low profit customers with loans maturing—obviously need to increase rate

Low profit customers with waivers in deposit accounts—no more waivers for such customers

Upon implementation nearly 100 intuitive Value Finders are configured for the Financial Institution.

In addition to intuitive segments of opportunities or Value Finders, the advanced analytical platform reveals statistically identified Value Finders which include:

Applying a profit equation to customers that have been with the financial institution for two years, a number of equations will result. Applying these same equations to customers that have been with the bank for 4 months + or − two months (2 to 6 month range) using regression, similar characteristics of account balances, services and transaction types and volumes would result in overlapping results. For the two year customers, perhaps 15% of customers are profitable, 75% are neutral to slightly negative and 10% are very unprofitable. Applying these same equations to the 2 to 6 month tenured customers, the equations would identify larger percentages and overlapping percentages because of residual errors. However, accounts with similar characteristics would be revealed and a focused effort of a series of actions and incentives would direct segments of customers to use products, services and transactions in a manner that results in improved revenue, retention and profit. When these customers reach the two year point, the percentage segments of profitable customers may now be 18%, 73% and 9% respectively. Repeat the process and these small percentage changes result in significant profit for the financial institution.

Iterative chi-squared and logistic regression or Random Forests regression will identify a customer's ability to repay. Such equations and identified segments of customers are ideal for the marketing of lines of credit, CD secured lines of credit and other credit and overdraft protection products.

Coupling a Loyalty Measure and Profitability Measure, early warnings result when customers have declining ACH transactions, number of Internet banking log-ins, out-of-the-norm deposit activity, and out-of-the-norm withdraws.

Statistically derived trends, and differences in trends, between regions, branches, officers, product types, loans with different collateral values, interest rates, loan-to-values, debt-to-income ratios will be identified to direct risk management or sales activity.

Using Value Finder and Action Management together, these data segments may be identified and portions of the data form each segment may be identified for a control group, campaign A and campaign B. Action Manager can then be used later (3-6 months) to measure success. Of course we'll incrementally apply “actions” to increase “success” until we have a best practice. At such time, the bank may skip the control group and multiple campaigns and simply use what has been proven to work best. Many other examples are possible. The advanced analytical methods described herein will identify opportunities identified through advanced statistical methods.

Advanced Statistical Methods used with Saggezza FI Solution described below. The Saggezza Financial Institution (“FI”) Solution uses advanced statistical methods to identify and direct action on what “matters most”. Chi-Squared and Analysis of Variance (ANOVA) methods, or Random Forests can be directed at different segments of customers: new to bank, with bank for ______ years, with 1-3 accounts vs. 4+, profitable vs. unprofitable, customers with a loan maturing soon, customers with no loan, customers with “high” deposits but no loan product, etc.

On these different segments of data, Saggezza uses a module of R that includes a Random Forests engine. The results are presented in a new user interface that allows one to quickly slice through data in a cube-type-method.

Random forests is a statistical method easily used in R. “Random forests” are a combination of tree predictors such that each tree depends on the values of a random vector sampled independently and with the same distribution for all trees in the forest. The generalization error for forests converges to a limit as the number of trees in the forest becomes large. The generalization error of a forest of tree classifiers depends on the strength of the individual trees in the forest and the correlation between them” (Breiman, Leo, “Random Forests,” Machine Learning, vol. 45, no. 1 (2001), p.5-32 (incorporated herein by reference in its entirety).

As a practical example, analyze, using Random forests, a data segment of customers that have been with the FI for more than 2 years but less than 5. Random forests will separate this list into groups of users based on collective statistically-identified characteristics. Within each cluster of customers (or trees), patterns will emerge.

Then identify customers in an early phase of “similar” characteristics. The FI Solution will suggest the directly (and proven) next products that will “grow” the customers along the same path of those with the FI for 2-5 years so that similar “groups” of profitable customers emerge.

Similarly, statistically analyze a group of profitable customers on which a specific action was taken. Perhaps “success” resulted best for customers with certain “attributes”. What results is a more focused action strategy while we can better separate the customers that do not have those attributes; and try different action. Again repeat these steps and we get an ever refined list of actions that “move meters”.

Statistically we will consider: different mixes of products, different combinations of transactions and services used on those products, different customer characteristics, compare actions within one region to another, within different sets of branches or officers, and compare different time periods.

Within different segments of data, the FI Solution will “stamp” a label for the different category of customer over time. As customers migrate from one data segment to another, we'll want to statistically investigate “why”. If the customer is migrating “up” (on a scale of retention or profit) then we'll want to identify the trigger and make that happen more. If the customer migrated “down” then we'll want to identify the trigger and try to correct for it.

Random forests, and other statistical measures, identify correlation coefficients. The correlation coefficients indicate the relative “strength” of that individual variable. Through iterations, such as “Cronbach's Alpha”, the advanced analytical does two things. It reweights the equation based on the correlation coefficients, reruns through permutations and identifies “the best” equation. Secondly, it removes a variable to see if the equation becomes more or less reliable. Essentially, Cronbach's devised a statistical method to measure “two sets of data in every way possible and computing the correlation coefficient for each split (Field, Andy, “Discovering Statistics Using IBM SPSS Statistics, Sage (2013), p. 708, incorporated hereby by reference in its entirety). The Cronbach equation simply measures the variance within the item and the covariance between a particular item and any other item on the scale. Cronbach measures the variance-covariance matrix of all items.

So in sum, a method as disclosed herein may include: 1) aggregate the data 2) segment the data (using chi-squared, ANOVA, and/or Random forests) 3) find the multiple regression model (most likely a linear function) 4) find the correlation coefficients, t-scores, and Cronbach Alpha, etc. 5) based on findings of 4, reweight the equation from 3, rerun and perfect over time=6) increasingly you may get more formulas running for different specific segments of data, but you get increasingly prescriptive equations.

FIG. 3 illustrates a method 300 that may be executed by a server system 102a in order to implement the above-described statistical techniques. The method 300 may include defining 302 a customer metric. The customer metric may be a value that corresponds to attributes such as loyalty, profitability, or some other attribute.

In one example, a statistical evaluation if performed with respect to a set of customers C1 who have ceased banking activities. And a set of customers C2 who have not ceased banking activities. For example, the banking activities A1 of customers C1 for a period of N months (e.g. six months or some other time period) may be compared to banking activities A2 of customers C1. The activities A1, A2 may be a set of values indicating a quantity of a particular activity (checks written, in-bank transactions, open accounts, credit accounts, checking accounts, saving accounts, etc.) or a set of records of activities. An activity A1 of a customer C1 may be a plurality of “bins” to which activities are assigned. For example, a bin may include a total number of a certain activity in certain time period (week, month, six months, year, etc.). A bin may include a series of values, such as the total number of a certain type of activity each week for the past six months or some other period. A bin may be a statistical characterization of activities, e.g. a rate of the decline or increase in frequency of an activity over a period, e.g. the average slope of a plot of the weekly totals for an activity over a time period (e.g. month, six months, or the like).

A loyalty metric may be computed according an equation that takes as inputs the activities A1, A2 and outputs likelihood that a customer will cease banking activities. The equation may be generated using a statistical technique such as logistical regression that takes as inputs the customer the activities Al of customers C1 and their status as ceasing banking activities and the activities A2 of customers C2 and their status as not having ceased banking activities. The logistic regression technique may then operate as known in the art and generate an equation taking as inputs values for a given set of activities AN and output a likelihood that the activities indicate that cessation of banking activities will occur (or a likelihood that customer activities will continue in some implementations).

In a similar manner, any set of activities AN or other attributes TN (demographic, geographic, etc.) of a set of customers (e.g. a set of computer records for the customers) and a measurable outcome (profitability, utilization rate) may be analyzed according to logistic regression to relate an estimate of the probability of the measurable outcome for a particular customer with given activities AN and attributes TN.

The method 300 may include defining 304 one or more customer development actions. Defining 304 one or more customer development actions may include receiving one or more human inputs describing or assigning an identifier to a particular customer development action. Customer development actions may include in-person solicitation, emailed offer, mailed offer, a promotion, and an offer for a particular banking product, or any other action that may be used to improve customer loyalty or banking utilization.

The method 300 may include identifying 306 a target customer segment. Identifying a customer segment may be performed by a computer by calculating the metric from step 302 for a plurality of customer records, comparing the metrics to a threshold condition, and selecting customer records with metrics meeting the threshold condition. For example, where the metric is a loyalty metric, customers records having a loyalty metric below a threshold may be selected as the target segment, where the higher loyalty metric indicates an estimated higher likelihood of continuing banking activities.

The method 300 may further include automatically dividing 308, by the server system, the target segment of customer records among M+1 groups, where M is the number of customer development actions received at step 304. In particular, each customer record may be assigned to one of the customer development actions D1 to DM or a control group G. The number of customer records assigned to each development action D1 to DM and control group G may be approximately equal (e.g. within 5%, preferably within 1% of the total number of customer records in the target segment).

The method 300 may include performing 312 each development action D1 to DM for the customers of the customer records assigned thereto at step 310. Likewise, for the customer records of the control group, none of the development actions D1 to DM are performed. Performing 312 the development actions may be facilitated by the server system 102a, such as by outputting lists of customers for whom to perform the action, automatically transmitting emails or invoking printing and mailing of promotional materials, and the like. Likewise, the server system 102am may receive inputs from users indicating a customer record and indicating that a given customer development action D1 to DM has been completed with respect to the customer corresponding to that customer record.

The method 300 may include recalculating 312 the customer metric of step 302 with respect to the customer records of the target segment subsequent to performing 310 the customer development actions and possibly subsequent some delay period during which additional banking activities AN may be performed (or not performed) by the customers of the target segment in response to the customer development actions. Any banking activities AN of customers in the target segment may be recorded as they occur by the server system 102a. Activities AN may be reported to the server system 102a in response to human inputs or automatic reporting by computer systems that interact with the customers.

The method 300 may further include performing statistical analysis with respect to the action segments corresponding to each development action D1 to DM. In particular, logistic regression, chi-squared regression, random forests regression, or other statistical technique may be used to relate recorded banking activities AN of customers and possibly customer attributes TN of customers to responsiveness to a particular development action. For example, an input data set may be a set of customers each with activities AN and attributes TN. Each customer may further include a development action identifier and values for the customer metric before and after execution of the development action corresponding to the development action identifier. The regression technique relates the values of the activities AN and attributes TN of a customer to a probability of a change in the customer metric in response to the development action, e.g. a change in the customer metric from not meeting a threshold condition to meeting the threshold condition. In particular, the activities AN and attributes TN of the customer may be input to the regression algorithm as the independent variables and the measured outcome of the customer development actions (e.g. a metric meeting or not meeting a threshold condition) is input as the dependent variable.

The output of the regression (logistical, chi-squared, random forests) is a set of equations that take as input a set of activities AN and attributes TN and outputs a probability that a customer will transition to having a customer record meeting the threshold condition in response to the development action. Multiple equations may be used such that each equation will identify a cluster of customer records having a similar set of activities AN and attributes TN that will be responsive to the development action. Accordingly, by applying a particular equation to a set of customer records, those customer records for whom the output of the equation is above a threshold value (e.g. a probability of above 90 percent, preferably above 95 percent, and more preferably above 99 percent) may be identified as corresponding to a cluster of customers that can be analyzed and further studied as a group of similar individuals. The equations resulting from the regression step may therefore be referred to as “clustering equations.”

Accordingly, the method 300 may include dividing 316 the target customer segment into sub-segments according to the clustering equations. Specifically, for each clustering equation for each development action, a segment of customer records having activities AN and attributes TN for which the clustering equations gives an above-threshold value may be assigned to a sub-segment for that equation.

For each sub-segment of customers, the steps 302-318 may be repeated 318 using the sub-segment as the “target segment.” Repeating 318 may be performed with some modifications. For example, the same set of development actions may be used such that step 304 is not repeated. However, in some embodiments, new development actions may be received from an operator.

The customer metric used during the repeating steps 318 may be the same or different. For example, the method described above with respect to step 302 for defining the customer metric may be repeated with respect to the new target segment. In this manner, the relationship of the activities AN and attributes TN of the customers of the new target segment may be more precisely mapped to a desired outcome (profitability, loyalty, etc.).

The present invention may be embodied in other specific forms without departing from its spirit or essential characteristics. The described embodiments are to be considered in all respects only as illustrative, and not restrictive.

1. A method for computerized customer management, the method comprising:
(a) calculating, by a server system, for each customer record of a first plurality of customer records, a metric as a function of customer banking actions recorded in the each customer record;
(b) identifying, by the server system, a second plurality of customer records from the first plurality of customer records having, the metric of the customer records of the second plurality of customer records meeting a threshold condition;
(c) receiving, by the server system, one or more action identifiers;
(d) segmenting, by the server system, the second plurality of customer records into one or more action segments each corresponding to one of the one or more action identifiers and a control segment that does not correspond to any of the one or more action identifiers; and
(e) invoking, by the server system, performance of actions corresponding to the one or more action identifiers with respect to customers corresponding to customer records in the one or more action segments.

2. The method of claim 1, wherein each customer record of the first plurality of customer records further includes a set of attributes describing a customer corresponding to the each customer record, the method further comprising:
(f) recalculating the metric for the second plurality of customer records; and
(g) generating, by the server system, one or more cluster equations each outputting a value that is a function of the set of attributes, the generating the one or more cluster equations including performing at least one of chi-squared logistic regression and random forests regression with respect to each of the action segments using the metric calculated at (f).

3. The method of claim 2, further comprising:
(h) segmenting the second plurality of customers according to the one or more cluster equations into one or more cluster segments;
performing (a) through (h) one or more times for each cluster segment substituting each cluster segment as the second plurality of customers.

4. The method of claim 3, wherein generating the one or more cluster equations comprises generating the cluster equations such that the cluster equations take as inputs the set of attributes and the customer banking actions of customer records in the action segments.

5. The method of claim 4, wherein the banking actions include at least one of:
deposits;
in-bank transactions;
open accounts;

6. The method of claim 5, wherein the set of attributes includes demographic attributes.

7. The method of claim 6, wherein the set of attributes includes geographic attributes.

9. The method of claim 1, further comprising generating the metric by:
identifying, by the server system, a set of former customer records of the first plurality of customer records that indicate a cessation of banking activities;
performing logistic regression with respect to the customer banking actions of the former customer records and the first plurality of customer records excluding the former customer records effective to generate a prediction function of the customer banking actions that correlates the customer banking actions to cessation of banking activities; and
calculating the metric for the first plurality of customers according to the prediction function.

10. The method of claim 1, further comprising generating the metric by:
identifying, by the server system, a first set of customer records from the first plurality of customers records meeting a threshold condition;
performing logistic regression with respect to the customer banking actions of the first set of customer records and the first plurality of customer records excluding the first set of customer records effective to generate a prediction function of the customer banking actions that correlates the customer banking actions to meeting the threshold condition; and
calculating the metric for the first plurality of customers according to the prediction function.

11. The method of claim 10, wherein the threshold condition is a revenue threshold.

12. The method of claim 10, wherein the threshold condition is utilization of a predetermined banking service.

13. The method of claim 1, wherein the metric is a profitability metric.

14. The method of claim 1, wherein the metric is a loyalty metric.

15. A system comprising one or more processing devices and one or more memory devices coupled to the one or more processing devices, the memory devices storing executable code effective to cause the one or more processors to:
(a) calculate for each customer record of a first plurality of customer records, a metric as a function of customer banking actions recorded in the each customer record, each customer record of the first plurality of customer records further including a set of attributes describing a customer corresponding to the each customer record;
(b) identify a second plurality of customer records from the first plurality of customer records having, the metric of the customer records of the second plurality of customer records meeting a threshold condition;
(c) receive one or more action identifiers;
(d) segment the second plurality of customer records into one or more action segments each corresponding to one of the one or more action identifiers and a control segment that does not correspond to any of the one or more action identifiers; and
(e) invoke performance of actions corresponding to the one or more action identifiers with respect to customers corresponding to customer records in the one or more action segments;
(f) recalculate the metric for the second plurality of customer records; and
(g) generate one or more cluster equations each outputting a value that is a function of the set of attributes, the generating the one or more cluster equations including performing at least one of chi-squared logistic regression and random forests regression with respect to each of the action segments using the metric calculated at (f).

16. The system of claim 15, wherein the executable code is further effective to cause the one or more processors to:
(h) segment the second plurality of customers according to the one or more cluster equations into one or more cluster segments;
perform (a) through (h) one or more times for each cluster segment substituting each cluster segment as the second plurality of customers.

17. The system of claim 16, wherein the executable code is further effective to cause the one or more processors to generate the one or more cluster equations by generating the cluster equations such that the cluster equations take as inputs the set of attributes and the customer banking actions of customer records in the action segments.

18. The system of claim 17, wherein the banking actions include at least one of:
deposits;
in-bank transactions;
open accounts; and
wherein the set of attributes includes demographic and geographic attributes.

19. The system of claim 15, wherein the executable code is further effective to cause the one or more processors to generate the metric by:
identifying a set of former customer records of the first plurality of customer records that indicate a cessation of banking activities;
performing logistic regression with respect to the customer banking actions of the former customer records and the first plurality of customer records excluding the former customer records effective to generate a prediction function of the customer banking actions that correlates the customer banking actions to cessation of banking activities; and
calculating the metric for the first plurality of customers according to the prediction function.

20. The system of claim 15, wherein the executable code is further effective to cause the one or more processors to generate the metric by:
identifying a first set of customer records from the first plurality of customers records meeting a threshold condition;
performing logistic regression with respect to the customer banking actions of the first set of customer records and the first plurality of customer records excluding the first set of customer records effective to generate a prediction function of the customer banking actions that correlates the customer banking actions to meeting the threshold condition; and
calculating the metric for the first plurality of customers according to the prediction function.
